(19) United States
(12) Patent Application Publication
(10) Pub. No.: US 2018/0267772 A1
(43) Pub. Date: Sep. 20, 2018

(54) ELECTRONIC DEVICE AND PROCESSING METHOD FOR INSTANTLY EDITING MULTIPLE TRACKS

(71) Applicant: Chung Shan Lee, Taipei (TW)

(72) Inventors: Chung Shan Lee, Taipei (TW); Kuang Hong Chen, Taipei (TW); Ying Hong Chen, Taipei (TW)

(21) Appl. No.: 15/611,743

(22) Filed: Jun. 1, 2017

(30) Foreign Application Priority Data
Mar. 20, 2017 (TW) 106109062

(51) Int. Cl. G06F 3/16; H04H 60/04; G06F 3/0482; G11B 31/02; G11B 20/10; G10H 1/00; G06F 3/0488

(52) U.S. Cl. CPC G06F 3/165; H04H 60/04; G06F 3/0482; G11B 31/02; G11B 20/10527; G10H 1/0041; G10H 2210/105; G11B 2020/10574; G11B 2020/10564; G10H 2220/096; G10H 2220/106; G10H 2240/016; G06F 3/0488

(57) ABSTRACT

An electronic device and a processing method for instantly editing multiple tracks are provided by the present invention, where the electronic device can instantly perform recording for the musical instrument and independent audio mixing. The electronic device can be connected to a first musical instrument and a second musical instrument, and records first audio data and second audio data. Oscillograms corresponding to the first and the second audio data are drawn on a touch screen of the electronic device, and multiple control keys are provided in an editing interface. The electronic device can randomly set a selected area in the oscillogram, and perform relevant audio data adjustment on the selected area. The present invention can be used in a portable musical instrument. A musical performer can perform recording and editing at any time and any place to create a good creation.

### CROSS-REFERENCE TO RELATED APPLICATIONS

The present application claims the benefit of Taiwanese Patent Application No. 106109062 filed on Mar. 20, 2017, the entire contents of which are hereby incorporated by reference.

### BACKGROUND OF THE INVENTION

### 1. Field of the Invention

The present invention relates to an audio data processing device and method, and in particular, to an electronic device and a processing method for instantly editing multiple tracks.

### 2. Description of the Related Art

A pickup is mainly used to capture resonance produced by a guitar (or another stringed instrument such as a bass, a ukulele, a violin, a viola, or a cello) and convert the resonance into an electronic signal. Specifically, commercially available pickups only capture musical sound and convert it into an electronic signal, and then send the electronic signal to an amplifier (such as a sound box) for sound amplification. Because the commercially available pickups lack an instant recording and editing function, limited by space or equipment, it is difficult for a creator to record the creation at any time and anyplace. To implement instant recording and editing, it is required to additionally use a recording interface and editing software, and therefore it is required to additionally carry a transmission interface, a recording interface, and an electronic device installed with editing software, which renders a recording and editing process in preliminary recording of music creation complicated and inconvenient. Moreover, because the conventional pickups do not have a recording function, recording cannot be implemented merely using the pickup and it is required to additionally use a recording device to implement recording. A pickup with a recording and editing function is proposed herein, which gives assistance in a preliminary recording phase of music creation; furthermore, to conduct detailed editing on the music creation to produce a musical composition, an audio file output by the pickup with the recording and editing function may be transmitted to professional editing software for detailed editing, thereby simplifying a music creation process.

### SUMMARY OF THE INVENTION

The present invention provides an electronic device for instantly editing multiple tracks, which is characterized by performing audio mixing on multiple tracks.

The electronic device for instantly editing multiple tracks of the present invention includes an input interface, a physical control knob, a storage unit, a touch screen, a shuttle control knob, an output interface, and a processing unit. The input interface is used to be connected to a first musical instrument and receive first audio data, or used to be connected to a second musical instrument and receive second audio data; the physical control knob is used to adjust audio data properties of the first audio data or adjust audio data properties of the second audio data; the storage unit is used to store a first audio file, a second audio file, an editing program, and a target file; the touch screen is used to display a menu selection interface or an editing interface of the editing program, where the menu selection interface is used to create a new file or select an existing file, and the file includes the target file and the first audio file; the editing interface includes at least one track editing area, an equalized editing area (EQ), a click key, a recording key, a play key, a loop key (loop), a mixer key, and a punch key (punch), and each track editing area includes a oscillogram, a volume column, a solo key (Solo), and a mute key, where the oscillogram is drawn according to a volume change at different time of a first audio data, the volume column indicates current volume of the played first audio data, and the equalized editing area is used to adjust a gain of the first audio data (or the second audio data); the shuttle control knob is used to trigger a click signal and a selection signal, and is used to select a start point and an end point of a selected area of the oscillogram in the track editing area; the output interface is electrically connected to a computer and transmits the target file to the computer; the processing unit is electrically connected to the input interface, the physical control knob, the storage unit, and the touch screen, loads the first audio data to the track editing area and displays a oscillogram of the first audio data, and loads the second audio data to another track editing area and displays a oscillogram of the second audio data; when the recording key of the touch screen is enabled, the processing unit sequentially displays waveforms of the received first audio data or second audio data in the track editing area, separately adjusts audio data properties of the first audio data or the second audio data according to the gain, and then stores the adjusted first audio data or second audio data as the first audio file or the second audio file; and when the mixer key of the touch screen is triggered, the processing unit mixes the first audio file and the second audio file to form the target file.

The present invention further provides a processing method for instantly editing multiple tracks, which includes the following steps: selecting an audio data source end and connecting the source end to an electronic device; selecting an editing program on a touch screen of the electronic device, and selecting to create a new file or open an existing file in a menu selection interface of the editing program; receiving, by the electronic device, first audio data from the audio data source end and storing it as a first audio file; drawing an editing interface on the touch screen of the electronic device, and drawing a first oscillogram of the first audio file in a track editing area of the editing interface; setting a start point and an end point in the oscillogram, and setting an interval from the start point to the end point in the first oscillogram as a selected area; adjusting audio data properties of the first audio file corresponding to the selected area; storing the modified first audio file in a storage unit of the electronic device; receiving, by the electronic device, second audio data, and storing it as a second audio file; drawing a second oscillogram of the second audio file in another track editing area of the editing interface; setting a selected area in the second oscillogram and adjusting audio data properties of the second audio file; completing adjustment of the audio data properties of the second audio file, and storing the second audio file in the storage unit; and mixing the first audio file and the second audio file, and outputting a target file.

The electronic device and processing method for instantly editing multiple tracks of the present invention not only can implement recording and audio mixing for a standalone apparatus, but also can record different tracks at different time and adjust the tracks. A user can complete works before audio mixing at the same time when recording is performed at a front end. In this way, to perform audio mixing at a rear end, it is unnecessary to perform recording for all musical instruments anew, which can reduce a work load at the rear end.

The features and implementation of the present invention are described in detail below with reference to the accompanying drawings and preferred embodiments.

### BRIEF DESCRIPTION OF THE DRAWINGS

FIG. 1A is a schematic architecture diagram of an electronic device of the present invention;

FIG. 1B is a schematic appearance diagram of physical control elements of the electronic device of the present invention;

FIG. 2A is a schematic diagram of a menu selection interface of the present invention;

FIG. 2B is a schematic diagram of another menu selection interface of the present invention;

FIG. 2C is a schematic diagram of another menu selection interface of the present invention;

FIG. 3A is a schematic diagram of an editing interface of the present invention;

FIG. 3B is a schematic diagram of an audio mixing interface of the present invention;

FIG. 3C is a schematic diagram of another audio mixing interface of the present invention;

FIG. 4 is a schematic diagram of a track editing area of the present invention;

FIG. 5A is a schematic operation diagram of setting a start point and an end point of a selected area of the present invention;

FIG. 5B is a schematic diagram of the selected area of the present invention;

FIG. 6A is a schematic diagram of overwriting a track in the selected area of the present invention;

FIG. 6B is a schematic diagram of the selected area when a track is switched in the present invention;

FIG. 7 is a schematic operation flowchart of the present invention;

FIG. 8A is a schematic diagram of another implementation pattern of the present invention;

FIG. 8B is a schematic diagram showing a connection between an electronic apparatus and a peripheral apparatus in another implementation pattern of the present invention;

FIG. 9A is a schematic diagram of another implementation pattern of the present invention; and

FIG. 9B is a schematic diagram of a peripheral apparatus in another implementation pattern of the present invention.

### DETAILED DESCRIPTION OF THE PREFERRED EMBODIMENTS

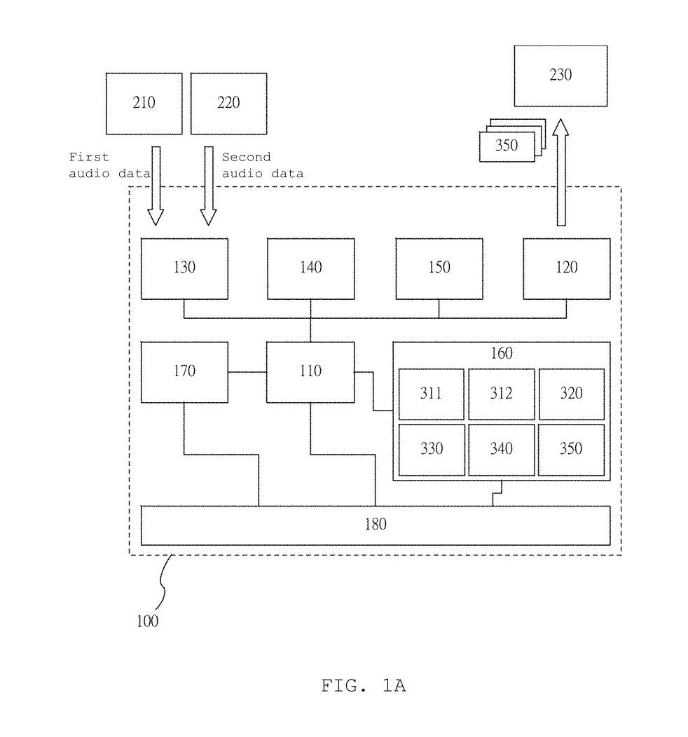

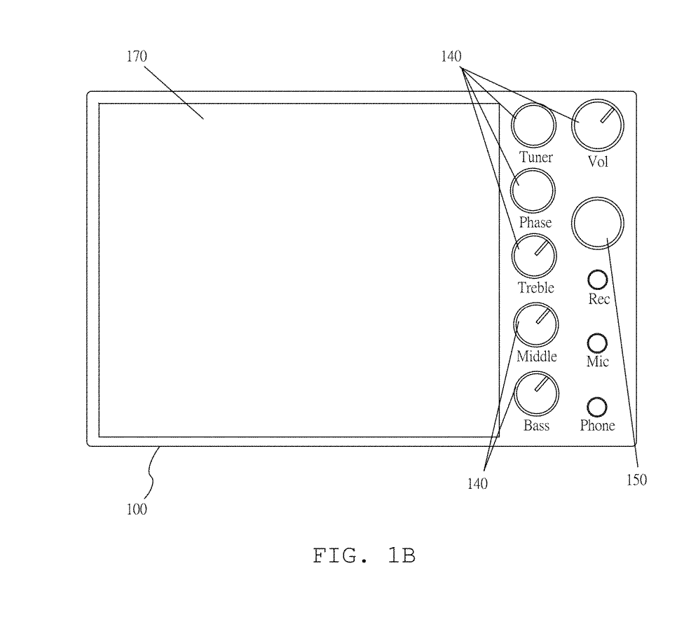

Referring to FIG. 1A and FIG. 1B which are schematic structural diagrams of elements of an electronic device 100 for instantly editing multiple tracks in the present invention, the electronic device 100 for instantly editing multiple tracks in the present invention includes a processing unit 110, an output interface 120, an input interface 130, a physical control knob 140, a shuttle control knob 150, a storage unit 160, a touch screen 170, and a power unit 180.

The processing unit 110 is electrically connected to the input interface 130, the physical control knob 140, the shuttle control knob 150, the output interface 120, the storage unit 160, the touch screen 170, and the power unit 180. The processing unit 110 converts multiple tracks received through the input interface 130 into audio files and stores the audio files. The processing unit 110 runs a menu selection interface 331, a display interface 332, or an editing interface 333 (the function interface will be described in another paragraph) in the storage unit 160.

A size of the electronic device 100 of the present invention depends on design made by a manufacturer, a type of a musical instrument, or a function orientation. Generally speaking, an electronic device 100 dedicated to a guitar may be in the size of an adult palm; or an electronic device 100 for a cello may be bigger than the foregoing electronic device 100 in size.

The input interface 130 is not limited to one or multiple interfaces. The input interface 130 may be connected to a first musical instrument 210 and receive first audio data, or is connected to a second musical instrument and receive second audio data. Herein, for description convenience, the input interface 130 is connected to two different musical instruments which are used as different input sources, while there may be more than three input sources in an actual application. A type of the input interface 130 may be, but is not limited to, a microphone connector, an AV connector, or a line-in connector (Line-in). The output interface 120 is electrically connected to a computer 230, and may transmit a target file 350 to the computer 230. A type of the output interface 120 is a USB interface or a fire wire interface.

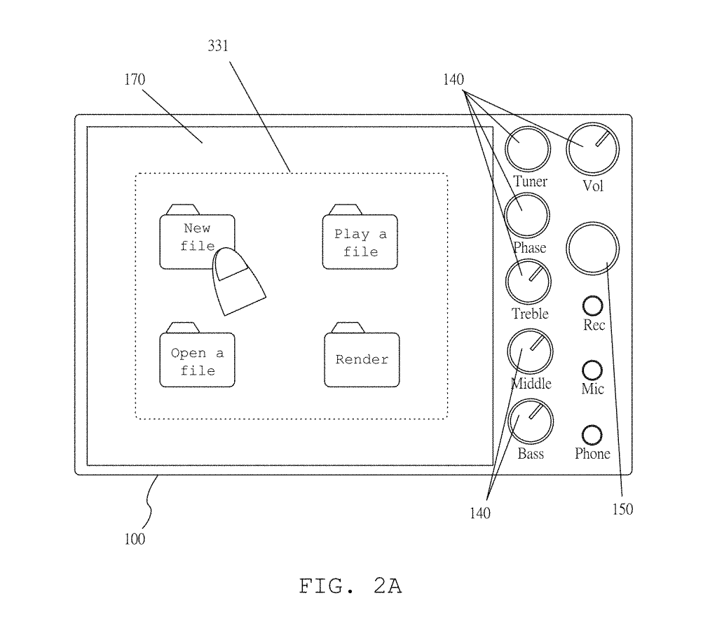

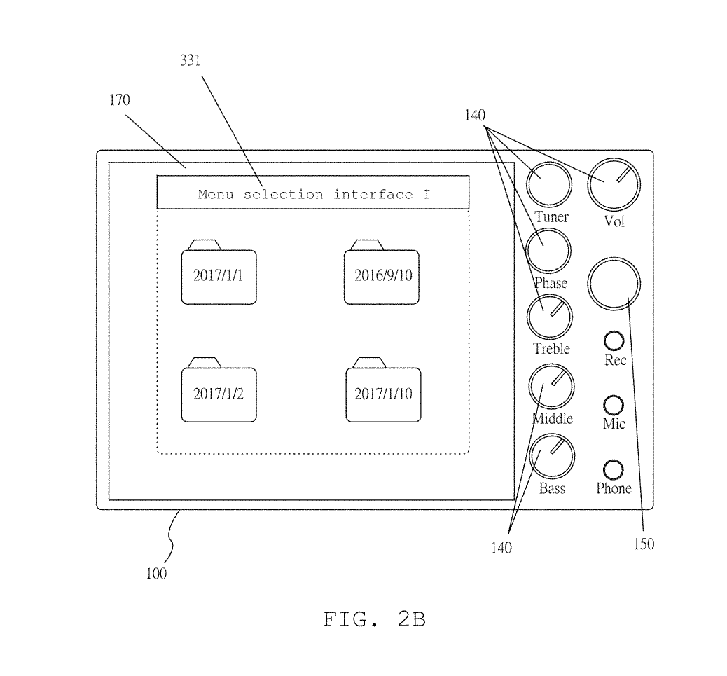

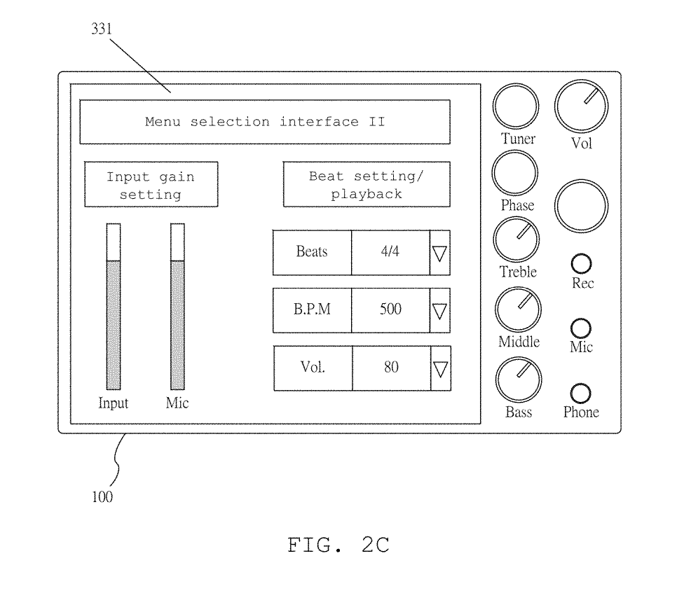

Referring to FIG. 2A, the electronic device 100 is disposed with at least one physical control knob 140. The physical control knobs 140 are used to adjust audio data properties of the first audio data (or the second audio data), or control positions of cursors in various function interfaces, where the audio data properties include volume, phase, bass, middle, and treble. The physical control knob 140 for the volume can control output volume of a track which is being played, and can further control volume during recording. A user can directly turn the physical control knob 140 for each audio data property to adjust the audio data property of a selected track. The shuttle control knob 150 can trigger a click signal and a selection signal. In other words, the user can press the shuttle control knob 150 to trigger the click signal or turn the shuttle control knob 150 to generate the selection signal. The electronic device 100 in the present invent ion may confirm a selected related function in various function interfaces (for example, the editing interface 333, the display interface 332, and the menu selection interface 331) by using the click signal, and may move a selected position of the function in the function interface by using the selection signal.

The storage unit 160 is used to store a first audio file 311 (or a second audio file 312), an editing program 320, a setting interface 330, an audio mixing interface 340, and the target file 350. The setting interface 330 includes a musical instrument field, a musical instrument volume adjustment table, a microphone volume adjustment table, a beat number adjustment table (Beats), and a Beats Per Minutes (BPM) adjustment table, where the musical instrument field is used to select a type of a musical instrument connected to the input interface 130. The editing program 320 includes multiple pages with different control functions, and in the present invention, the editing program 320 includes the menu selection interface 331, the display interface 332, or the editing interface 333. The editing program 320 adjusts input audio data by using the foregoing function interfaces.

The touch screen 170 may display the menu selection interface 331, the display interface 332, or the editing interface 333 of the editing program 320. Referring to FIG. 2A and FIG. 2B, the menu selection interface 331 is used to create a new file or select an existing file. When the user selects to create a new file, referring to FIG. 2C, the touch screen 170 additionally displays a bit rate selection field 3311 and a sampling frequency selection field 3312 of the target file 350. The display interface 332 is used to display audio data properties of the first audio data or the second audio data when being received. Referring to FIG. 2C, fields corresponding to volume, phase, bass, middle, and treble are drawn in the display interface 332. The foregoing file includes the target file 350 and the first audio file, or many other audio files.

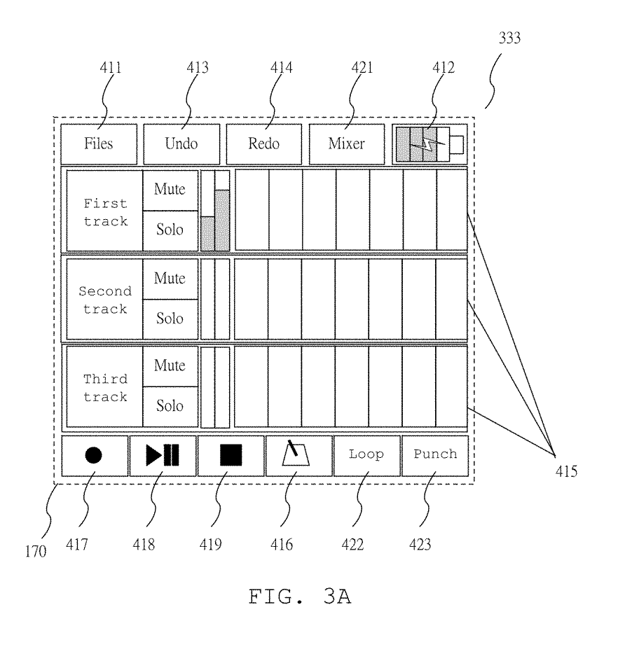

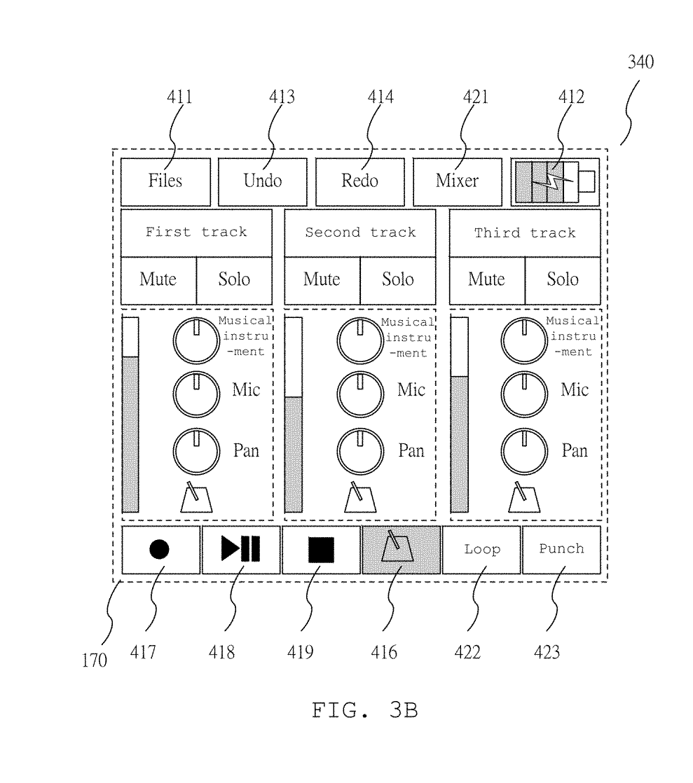

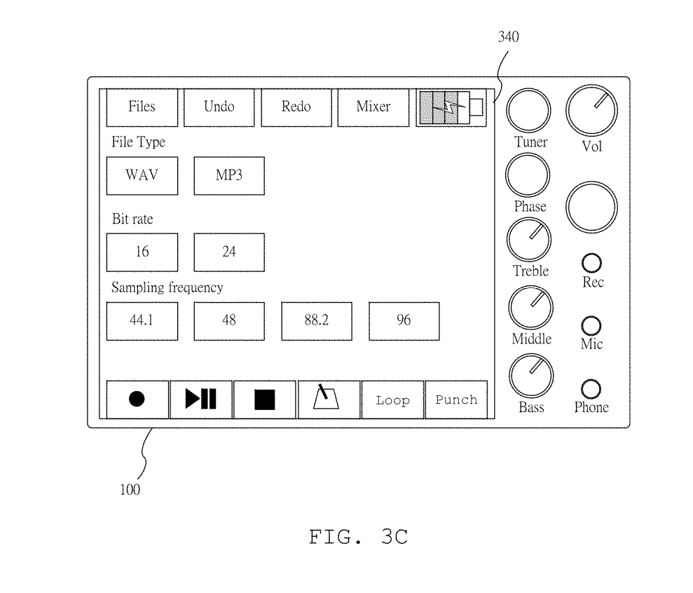

The editing interface 333 of the present invention includes a file key 411, a power field 412, an undo key 413, a redo key 414, at least one track editing area 415, an equalized editing area (EQ), a click key 416 (click), a recording key 417, a play key 418, a stop key 419, a mixer key 421 (mixer), a loop key 422 (loop), and a punch key 423 (punch). The foregoing keys are virtual keys generated on the touch screen 170. Refer to FIG. 3A, which is a schematic appearance diagram of the editing interface 333. The arrangement of the keys may be different on different touch screens 170. The loop key 422 and the punch key 423 need to cooperate with the selected area 510, and will be described later accordingly.

The equalized editing area is used to display each frequency band of a track corresponding to the selected track editing area 415, and may further be used to adjust a gain of each track. The click key 416 is used to set turning on or turning off of a beat prompt tone, and playback of the beat prompt tone is not incorporated into track recording. When the recording key 417 is triggered, recording of an input track signal is started. After the recording key 417 is triggered, the processing unit 110 first plays prepared sounds which are several beats and then starts input of the first audio data 311 or the second audio data 312. When the user disables the recording key 417, recording of a current track is stopped. The play key 418 not only can be used to play a track in the track editing area 415, but also can be used to play a track in a selected area 510 if the selected area 510 exists in the track editing area 415. After the mixer key 421 is triggered, the touch screen 170 displays the audio mixing interface 340.

Referring to FIG. 3B, the audio mixing interface 340 includes microphone input volume, musical instrument input volume, master volume of a track, panorama (pan), a mute key 4164 and a solo key 418 (Solo). The recording key 417 in the audio mixing interface 340 is used to mix multiple tracks in the track editing area 415, and output one target file 350. A type of the target file 350 is an audio file (WAV), an lossless compression audio file, or a lossy compression audio file. Referring to FIG. 3C, in the audio mixing interface 340, when the user selects the click key 416, the user may adjust beats of a selected track.

The undo key 413 is used to cancel a previous editing action, so that the user makes a correction when there is an error in an operation. The redo key 414 is used to repeat a previous editing action, so that the user can repeat the identical editing processing in such a manner.

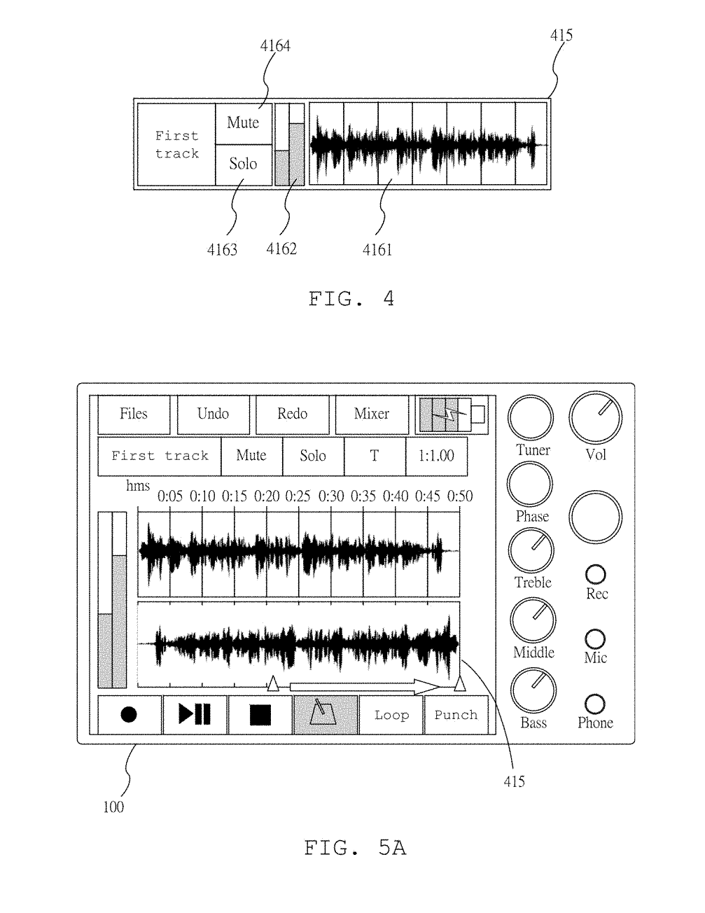

Each track editing area 415 includes a oscillogram 4161, a volume column 4162, a solo key 4163 (Solo), and a mute key 4164 (Mute), and refer to FIG. 4, which is a schematic diagram of a track editing area of the present invention. The oscillogram 4161 is drawn according to volume change at different time of a first audio data, and the volume column 4162 indicates current volume of the played first audio data. By using the first audio data and the second audio data as examples, the processing unit 110 loads the first audio data to the track editing area 415 and displays the oscillogram 4161 of the first audio data, and the processing unit 110 loads the second audio data to another track editing area 415 and displays a oscillogram 4161 of the second audio data. The processing unit 110 adjusts audio data properties of the first audio data according to a gain, and stores the edited first audio data as a first audio file. Likewise, recording of another track is the same as the foregoing processing. In the present invention, besides a audio file may be edited after recoding is completed, the user may add a specified sound effect into a audio file recording process. Although below description is made based on a completed audio file, the user may edit, during an actual application by using the described operation, audio data that is being recorded.

When the solo key 4163 is triggered, tracks other than the selected track are muted during playback. When the user triggers the mute key 4164, the corresponding track may not be mixed with other tracks during playing. In addition, a track editing area 415 on which rendering, recording, or other processing is currently performed is marked in a different color, to differentiate from other unused track editing areas 415.

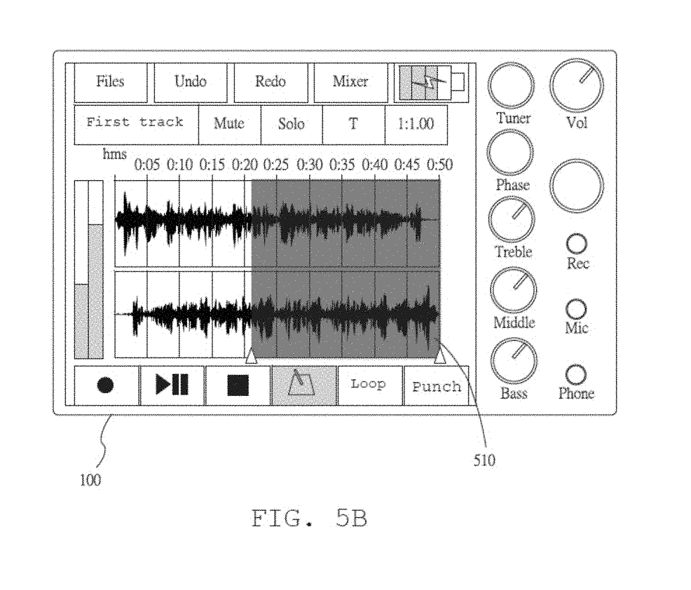

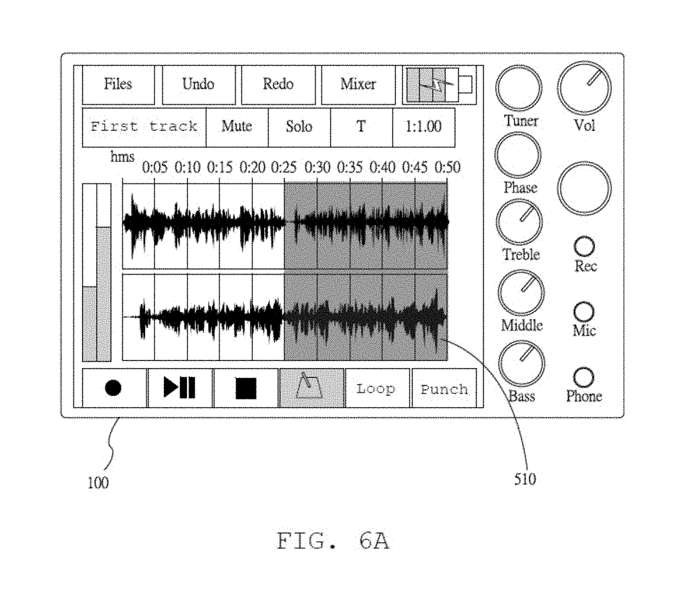

The user may select a to-be-edited track editing area 415 in FIG. 5A. When the user select a random track editing area 415, the user may turn the shuttle control knob 150 so that a cursor moves left and right in the oscillogram 4161. The user may move the cursor to a specific position and press the shuttle control knob 150. When the user presses the shuttle control knob for the first time, the processing unit 110 sets the position in the oscillogram 4161 as a start point of a selected area 510. Then, the user turns the shuttle control knob 150 again to move the cursor and presses the shuttle control knob 150, to set an end point of the selected area 510. At the same time, a bright white area in the oscillogram 4161 in FIG. 5B is used as the selected area 510. In addition, the present invention may further determine a cursor forwarding range corresponding to each level of the shuttle control knob 150 according to foregoing setting related to a mark of the beat number.

When the user triggers the loop key 422, the user may turn the shuttle control knob 150 to set a position of the cursor in the oscillogram 4161. The user may set an interval length of the selected area 510 in the foregoing manner. After setting of the selected area 510 is completed, the selected area 510 is enlarged by the processing unit 110 and fills the entire touch screen 170. When the user touches the loop key 422 again, the processing unit 110 stops playing the audio data and resumes displaying an image of the track editing area 415.

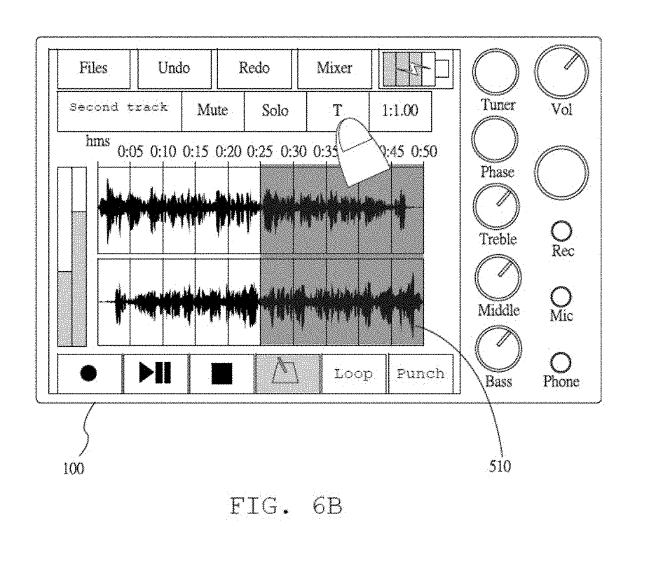

The punch key 423 is used to overwrite an existing track. When the user finds that there are some defects in the recorded track, the user may select apart (that is, the selected area 510) with the defects from the oscillogram 4161. After setting of the selected area 510 is completed, the user may enable the punch key 423 and re-record a track clip in the selected area 510. In other words, referring to FIG. 6A, the user may repeat recording the track part with defects, and overwrite a newly recorded track to the selected area 510.

In addition, the user may select a next track (a key “T” in FIG. 6A indicates the next track) in the editing interface 333. The processing unit 110 circles a time segment, identical with a corresponding time segment of the selected area 510, of the next track. In other words, indifferent tracks, the selected area 510 appears in a same time segment. In this way, the user may perform a switch between different tracks and does not need to set the selected area 510 again, as shown in FIG. 6B.

The loop key 422 and the punch key 423 in the present invention may be used together. The user may first trigger the loop key 422 and set a corresponding selected area 510. Then, the user triggers the punch key 423 and sets a selected area 510 into which a track is to be punched. After completion of punching, the processing unit 110 jumps to the selected area 510 set by the loop key 422 and plays the track. In such a case, when the processing unit 110 completes playback of the track in the selected area 510 set by the loop key 422, an overwriting prompt appears on the touch screen 170. The user may select to overwrite the track, or discard the track and perform re-recording. In this way, the user may reduce the number of times to touch the recording key 417 and the play key 418 in a track selection process. The power unit 180 may be external power or a built-in battery. The power unit 180 is used to supply operation power for the processing unit 110, the storage unit 160, and the touch screen 170.

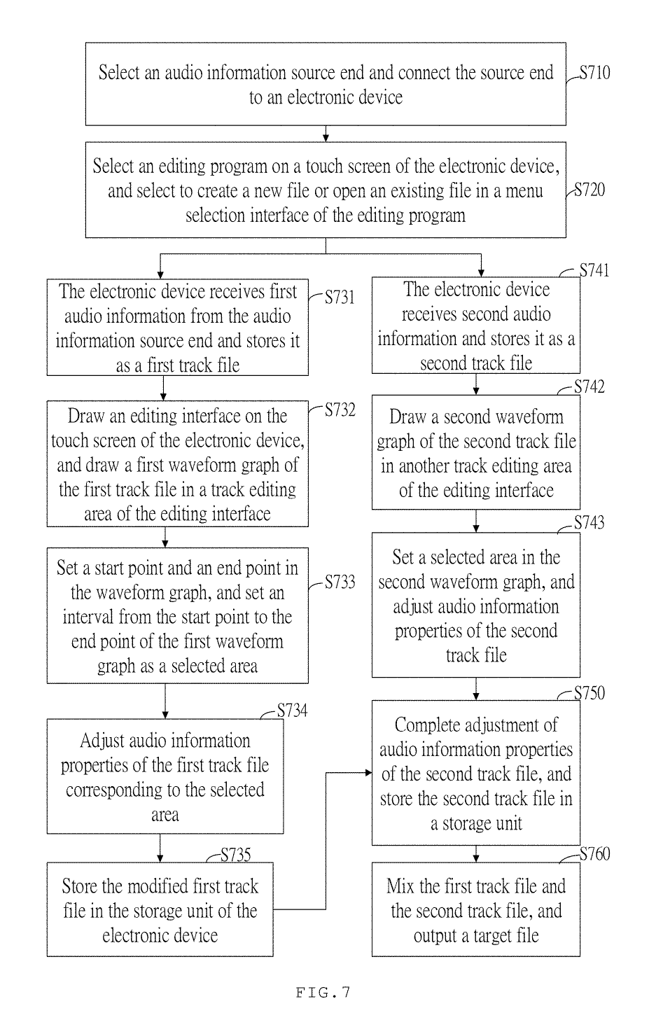

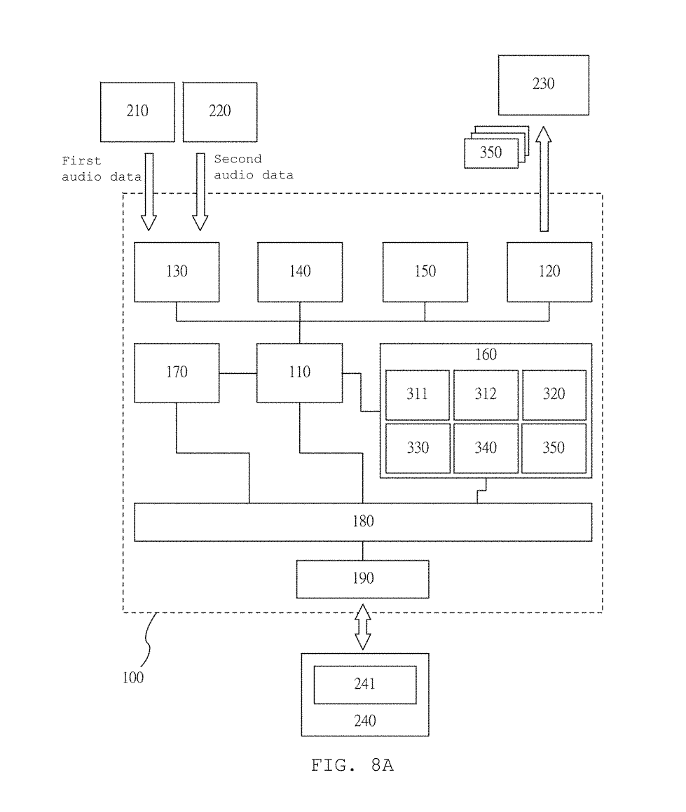

To clearly describe a main operation manner of the present invention, refer to FIG. 7, which is a schematic operation flowchart of the present invention. A processing method for instantly editing multiple tracks in the present invention includes the following steps:

Step S710: select an audio data source end and connect the source end to an electronic device;

Step S720: select an editing program on a touch screen of the electronic device, and select to create a new file or open an existing file in a menu selection interface of the editing program;

Step S731: the electronic device receives first audio data from the audio data source end and stores it as a first audio file;

Step S732: draw an editing interface on the touch screen of the electronic device, and draw a first oscillogram of the first audio file in a track editing area of the editing interface;

Step S733: set a start point and an end point in the oscillogram, and set an interval from the start point to the end point in the first oscillogram as a selected area;

Step S734: adjust audio data properties of the first audio file corresponding to the selected area;

Step S735: store the modified first audio file in a storage unit of the electronic device;

Step S741: the electronic device receives second audio data, and stores it as a second audio file;

Step S742: draw a second oscillogram of the second audio file in another track editing area of the editing interface;

Step S743: set a selected area in the second oscillogram and adjust audio data properties of the second audio file;

Step S750: complete adjustment of the audio data properties of the second audio file, and store the second audio file in the storage unit; and

Step S760: mix the first audio file and the second audio file, and output a target file.

First, a user may see a menu selection interface 331 on a touch screen 170. The user may open an existing file or may also create a new file, as shown in FIG. 2A. The following uses the new file as an example and makes descriptions about processing during track recording and audio mixing.

Then, the user selects a musical instrument (that is, an audio data source end) and connects the musical instrument to an electronic device 100. Herein, description is made by using an example in which the electronic device 100 is connected to a first musical instrument 210 and a second musical instrument. An input track signal corresponding to the first musical instrument 210 is defined as first audio data, and a oscillogram 4161 is displayed in a first track editing area 415. An input track signal corresponding to the second musical instrument is defined as second audio data, and a oscillogram 4161 is displayed in a second track editing area 415.

The user may first enter the menu selection interface 331 before recording, and set a bit rate and a sampling rate at which recording is to be performed for the first musical instrument 210 (or the second musical instrument). The user may further set the number of beats and BMP in a setting interface 330. After touching a beat number adjustment table or a BMP adjustment table, the user may select a corresponding option from the field, as shown in FIG. 2B. The user may further determine various related properties of an output target file 350 by using a bit rate selection field 3311 and a sampling frequency selection field 3312 of the menu selection interface 331, where the bit rate is 32/64/128/192/320 kbps, and the sampling frequency is 44.1/48/88.2/96 kHz.

When the electronic device 100 does not perform recording, the user may see, from a display interface 332, information, such as volume, phase, middle, bass, and treble, that is input when the first musical instrument 210 is played. After the user enables the recording key 417, the electronic device 100 starts recording the received first audio data. The electronic device 100 converts the received first audio data into a first audio file and temporarily stores the first audio file in a storage unit 160. At the same time when the first audio data is input, a processing unit 110 also draws a corresponding first oscillogram 4161 in a track editing area 415 according to the first audio data. Likewise, for the second musical instrument, the processing unit 110 also draws a second oscillogram 4161 corresponding to the second audio data in a track editing area 415 of the second audio data.

After completing the recording of the first audio file and the second audio file, the user may select the two track editing areas 415 on the touch screen 170 and click a mixer key 421. At the same time, the touch screen 170 displays an audio mixing interface 340. The user may adjust microphone input volume, musical instrument input volume, master volume of each track, panorama (pan), a mute key, and a solo key 418 (Solo) of each track in the audio mixing interface 340. The processing unit 110 performs audio mixing processing on the first audio file and the second audio file, and outputs a target file 350. If the electronic device 100 is connected to a computer 230, the electronic device 100 may transmit the target file 350 to the computer 230.

In a process of recording the first audio file (or the second audio file), the user may play the first audio file or may also edit a part of the first audio file. The user selects a to-be-edited track and clicks a track editing area 415 of the track. Then, the user turns a shuttle control knob 150 and moves a cursor in the track editing area 415. The cursor moves in a unit determined by the number of beats which is described above. The user selects a start point and an end point of the to-be-edited track in the oscillogram 4161 and defines a selected interval as a selected area 510. The selected area 510 is marked in a different brightness or color to differentiate from other parts of the oscillogram 4161. The user may repeatedly listen to the track in the selected area 510 by using a loop key 422, and may further re-record the track by using a punch key 423 and overwrite a re-recorded track to the selected area 510.

When the user finds that some defects exist in a recorded track, the user may set a selected area 510 containing the defects in the oscillogram 4161. After setting of the selected area 510 is completed, the user may enable the punch key 423 and re-record a track clip in the selected area 510. In other words, the user may repeat recording the track part with defects, and overwrite a newly recorded track to the selected area 510.

For the second audio data, the user may perform corresponding processing on the second audio data in the foregoing manner, and the second audio file is generated. If recording is needed for another musical instrument, the electronic device 100 of the present invention can also record third audio data or more audio data files. After the user completes recording of all audio files, the user may trigger the mixer key 421 and select multitrack recording from the audio mixing interface 340. The processing unit 110 mixes the selected audio files and outputs a target file 350.

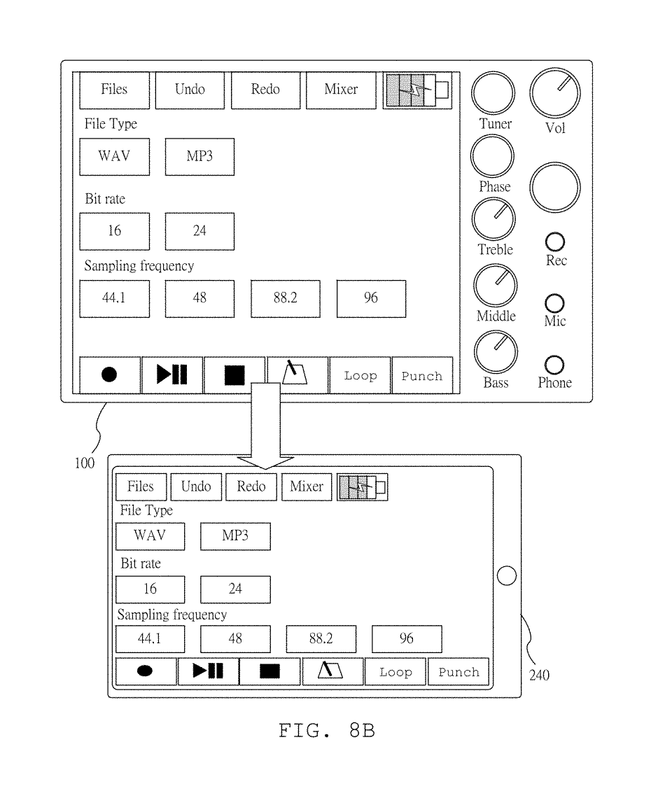

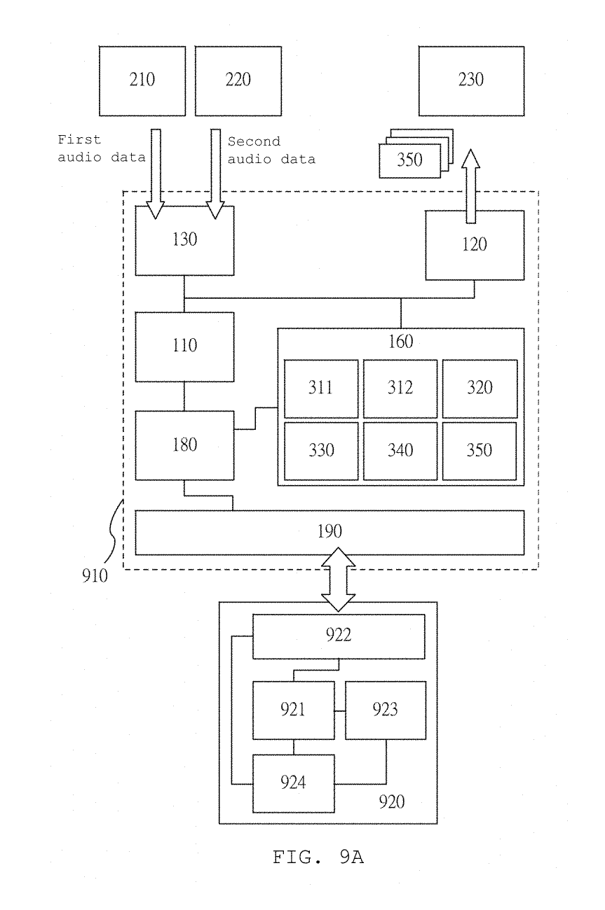

In addition to the foregoing implementation pattern, referring to FIG. 8A, the present invention further provides another implementation pattern. This implementation pattern at least includes an electronic apparatus 100 and a peripheral apparatus 240. The electronic apparatus 100 is used to receive first audio data from a first musical instrument 210 (or second audio data from a second musical instrument 220). The electronic apparatus 100 is further connected to the peripheral apparatus 240 by using a cable or in a wireless transmission manner.

The electronic apparatus 100 includes a processing unit 110, an output interface 120, an input interface 130, a physical control knob 140, a shuttle control knob 150, a storage unit 160, a touch screen 170, a power unit 180, and a transmission unit 190. The processing unit 110 is electrically connected to the input interface 130, the physical control knob 140, the shuttle control knob 150, the output interface 120, the storage unit 160, the transmission unit 190, the touch screen 170, and the power unit 180. Functions of the input interface 130, the physical control knob 140, the shuttle control knob 150, the output interface 120, the storage unit 160, the touch screen 170, and the power unit 180 are identical with those described above, and therefore are not repeated herein again. The transmission unit 190 is electrically connected to the processing unit 110. In addition to being connected to the peripheral apparatus 240, the transmission unit 190 is further used to transmit a menu selection interface (or an editing interface) to the peripheral apparatus 240.

A type of the transmission unit 190 may be a physical cable such as a USB or a fire wire, or may also be implemented through Bluetooth or a Wi-Fi network. When the electronic apparatus 100 is connected to the peripheral apparatus 240 by using the transmission unit 190, an operation screen of the peripheral apparatus 240 may display the menu selection interface 331 (a display interface 332 or an editing interface 333). The user may further select a corresponding function or change a related set value in the menu selection interface 331 by using the operation screen of the peripheral apparatus 240, as shown in FIG. 8B.

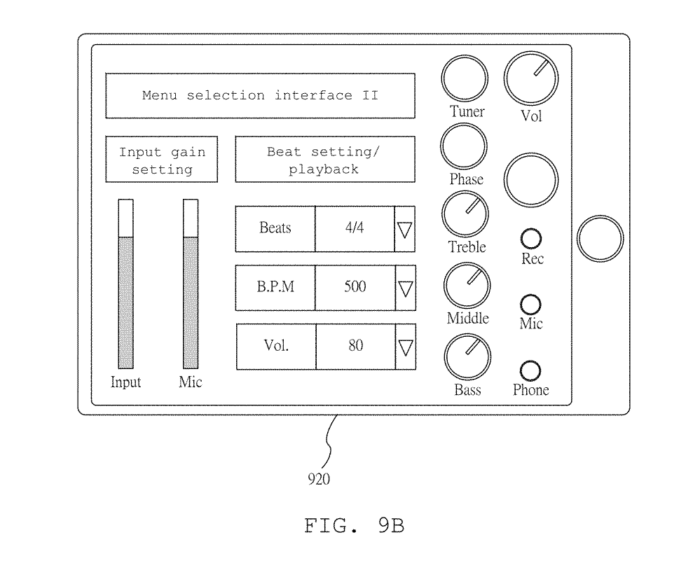

Based on the foregoing implementation pattern, referring to FIG. 9A, the present invention further provides another implementation pattern. This implementation pattern at least includes an electronic apparatus 910 and a peripheral apparatus 920. The electronic apparatus 910 includes a first processing unit 911, an input interface 912, a storage unit 913, a power unit 914, and a first transmission unit 915. The first processing unit 911 is electrically connected to the input interface 912, the storage unit 913, the power unit 914, and the first transmission unit 915. The first processing unit 911 is used to run an editing program 320 and a mapping program 916 in the storage unit 913. The input interface 912 is used to receive first audio data emitted by a first musical instrument 210. The first processing unit 911 outputs a first audio data file according to the received first audio data and corresponding operations. The first transmission unit 915 may be selectively connected to a computer or the peripheral apparatus 920. When the electronic apparatus 910 is connected to the computer 230, the electronic apparatus 910 may transmit the first audio data file to the computer 230. When the electronic apparatus 910 is connected to the peripheral apparatus 920, the user may control operations related to the electronic apparatus 910 by using the peripheral apparatus 920.

The peripheral apparatus 920 includes a second processing unit 921, a second transmission unit 922, an operation screen 923, and a battery unit 924. A type of the peripheral apparatus 920 may be a mobile phone or a tablet PC. The second processing unit 921 is electrically connected to the second transmission unit 922, the operation screen 923, and the battery unit 924. The battery unit 924 is used to supply operation power for the second processing unit 921, the second transmission unit 922, and the operation screen 923. The second transmission unit 922 is used to be connected to the electronic apparatus 910, and receive related data of the mapping program 916. The second processing unit 921 draws related interfaces of the editing program 320 on the operation screen 923 according to the data of the mapping program 916, as shown in FIG. 2A to FIG. 6B. When the electronic apparatus 910 receives the first audio data from the first musical instrument 210, the electronic apparatus 910 further simultaneously draws, in addition to interfaces designated by the user, processing images (for example, a oscillogram of the first audio data) related to the first audio data. In this implementation pattern, a virtual shuttle control knob and a virtual control knob are introduced into a target file 350, a menu selection interface 331, a display interface 332, and an editing interface 333 of the editing program 320. The user may control related functions (refer to the editing program and related operations that are described above) of the electronic apparatus 910 by using the peripheral apparatus 920, as shown in FIG. 9B.

An electronic device 100 and a processing method for instantly editing multiple tracks in the present invention not only can implement recording and audio mixing for a standalone apparatus, but also can record different tracks at different time and adjust the tracks. A user can complete works before audio mixing at the same time when recording is performed at a front end. In this way, to perform audio mixing at a rear end, it is unnecessary to perform recording for all musical instruments anew, which can reduce a work load at the rear end. Moreover, in a process of recording a audio file, the user can add a to-be-edited sound effect into the audio file at any time.

The present invention is disclosed above by using preferred embodiments, but the present invention is not limited thereto. Any person skilled in the art can make some changes and modifications without departing from the spirit and scope of the present invention, and therefore, the protection scope of the patent of the present invention is subject to claims in the specification.

### REFERENCE NUMBERS

100 Electronic device
110 Processing unit
120 Output interface
130 Input interface
140 Physical control knob
150 Shuttle control knob
160 Storage unit
170 Touch screen
180 Power unit
190 Transmission unit
210 First musical instrument
220 Second musical instrument
230 Computer
240 Peripheral apparatus
311 First audio file
312 Second audio file
320 Editing program
331 Menu selection interface
332 Display interface
333 Editing interface
3311 Bit rate selection field
3312 Sampling frequency selection field
340 Audio mixing interface
350 Target file
411 File key
412 Power field
413 Undo key
414 Redo key
415 Track editing area
416 Click key
417 Recording key
418 Play key
419 Stop key
421 Mixer key
422 Loop key
423 Punch key
4161 Oscillogram
4162 Volume column
4163 Solo key
4164 Mute key
510 Selected area
910 Electronic apparatus
911 First processing unit
912 Input interface
913 Storage unit
914 Power unit
915 First transmission unit
916 Mapping program
920 Peripheral apparatus
921 Second processing unit
922 Second transmission unit
923 Operation screen
924 Battery unit

What is claimed is:

1. An electronic device for instantly editing multiple tracks, wherein audio mixing is performed on multiple tracks, and the electronic device for instantly editing multiple tracks comprises:
an input interface, used to be connected to a first musical instrument and receive first audio data from the first musical instrument, or used to be connected to a second musical instrument and receive second audio data;
at least one physical control knob, used to adjust audio data properties of the first audio data or adjust audio data properties of the second audio data;
a storage unit, used to store a first audio file, a second audio file, an editing program, and a target file;
a touch screen, used to display a menu selection interface or an editing interface of the editing program, wherein the menu selection interface is used to create a new file or select an existing file, and the file comprises the target file and the first audio file;
the editing interface comprises at least one track editing area, an equalized editing area (EQ), a click key, a recording key, a play key, a loop key (loop), a mixer key, and a punch key (punch);
each track editing area comprises a oscillogram, a volume column, a solo key (Solo), and a mute key, wherein the oscillogram is drawn according to a volume change at different time of a first audio data, the volume column indicates current volume of the played first audio data, and the equalized editing area is used to adjust a gain of the first audio data or the second audio data;
a shuttle control knob, used to trigger a click signal and a selection signal, and used to select a start point and an end point of a selected area of the oscillogram in the track editing area;
an output interface, electrically connected to a computer and used to transmit the target file to the computer; and
a processing unit, electrically connected to the input interface, the physical control knob, the storage unit, and the touch screen, wherein the processing unit loads the first audio data to the track editing area and displays a oscillogram of the first audio data, and loads the second audio data to another track editing area and displays a oscillogram of the second audio data;
wherein when the recording key is enabled, the processing unit sequentially displays waveforms of the received first audio data or second audio data in the track editing area, adjusts audio data properties of the first audio data or the second audio data according to the gain, and then stores the adjusted first audio data or second audio data as the first audio file or the second audio file; and
when the mixer key is triggered, the processing unit mixes the first audio file and the second audio file to form the target file.

2. The electronic device for instantly editing multiple tracks according to claim 1, wherein a type of the input interface is a microphone connector or a line-in connector; a type of the output interface is a USB interface or a fire wire interface; a type of the target file is an audio file (WAV), an lossless compression audio file, or a lossy compression audio file; and the menu selection interface further comprises a bit rate selection field and a sampling frequency selection field of the target file.

3. The electronic device for instantly editing multiple tracks according to claim 2, further comprising a transmission unit, wherein the processing unit is electrically connected to the transmission unit, runs a mapping program, and projects the menu selection interface and the editing interface to a peripheral apparatus by using the transmission unit, so that an operation screen of the peripheral apparatus displays the menu selection interface or the editing interface.

4. The electronic device for instantly editing multiple tracks according to claim 1, wherein the shuttle control knob is turned to generate the selection signal, so that an indicator moves in the oscillogram; and the shuttle control knob is hit to generate the start point and the end point of the selected area.

5. The electronic device for instantly editing multiple tracks according to claim 4, wherein the editing program further comprises a setting interface; the setting interface comprises a musical instrument field, a musical instrument volume adjustment table, a microphone volume adjustment table, a beat number adjustment table (Beats), and a Beats Per Minutes (BPM) adjustment table; and the musical instrument field is used to select a type of a musical instrument connected to the input interface.

6. The electronic device for instantly editing multiple tracks according to claim 1, wherein when the mixer key is enabled, the processing unit displays an audio mixing interface on the touch screen, and the audio mixing interface comprises microphone input volume, musical instrument input volume, master volume of a track, panorama (pan), a mute key and a solo key (Solo).

7. A processing method for instantly editing multiple tracks, wherein audio mixing is performed on multiple tracks, and the processing method for instantly editing multiple tracks comprises the following steps:
selecting an audio data source end and connecting the source end to an electronic device;
selecting an editing program on a touch screen of the electronic device, and selecting to create a new file or open an existing file in a menu selection interface of the editing program;
receiving, by the electronic device, first audio data from the audio data source end and storing it as a first audio file;
drawing an editing interface on the touch screen of the electronic device, and drawing a first oscillogram of the first audio file in a track editing area of the editing interface;
setting a start point and an end point in the oscillogram, and setting an interval from the start point to the end point in the first oscillogram as a selected area;
adjusting audio data properties of the first audio file corresponding to the selected area;
storing the modified first audio file in a storage unit of the electronic device;
receiving, by the electronic device, second audio data, and storing it as a second audio file;
drawing a second oscillogram of the second audio file in another track editing area of the editing interface;
setting a selected area in the second oscillogram and adjusting audio data properties of the second audio file;
completing adjustment of the audio data properties of the second audio file, and storing the second audio file in the storage unit; and
mixing the first audio file and the second audio file, and outputting a target file.

8. The processing method for instantly editing multiple tracks according to claim 7, wherein the enabling the editing program further comprises:
selecting a menu selection interface, to open the existing file; and
drawing the first oscillogram or the second oscillogram corresponding to the first audio file or the second audio file of the selected file.

9. The processing method for instantly editing multiple tracks according to claim 7, wherein after the setting a selected area, the method further comprises:
selecting a loop key in the editing interface; and
repeatedly playing the first audio file or the second audio file corresponding to the selected area, till the loop key is disabled.

10. The processing method for instantly editing multiple tracks according to claim 7, wherein after the setting a selected area, the method further comprises:
selecting a punch key and a recording key in the editing interface; and
receiving new first audio data, and overwriting the first audio file in the selected area by using the new first audio data.
